(19) United States
(12) Patent Application Publication
(10) Pub. No.: US 2026/0188729 A1
(43) Pub. Date: Jul. 2, 2026

(54) ALL-SOLID-STATE SECONDARY BATTERY AND MANUFACTURING METHOD FOR THE SAME

(71) Applicant: ELECTRONICS AND TELECOMMUNICATIONS RESEARCH INSTITUTE, Daejeon (KR)

(72) Inventors: Dong Ok SHIN, Daejeon (KR); Young-Gi LEE, Daejeon (KR); Jaecheol CHOI, Daejeon (KR); Seok Hun KANG, Daejeon (KR)

(21) Appl. No.: 19/402,358

(22) Filed: Nov. 26, 2025

(30) Foreign Application Priority Data
Nov. 29, 2024 (KR) 10-2024-0175589
Apr. 14, 2025 (KR) 10-2025-0048180

(51) Int. Cl. H01M 10/0562; H01M 4/02; H01M 4/04; H01M 4/36; H01M 4/48; H01M 4/583; H01M 4/62; H01M 10/058

(52) U.S. Cl. CPC H01M 10/0562; H01M 4/0416; H01M 4/0435; H01M 4/362; H01M 4/48; H01M 4/583; H01M 4/623; H01M 10/058; H01M 2004/021; H01M 2004/027; H01M 2300/0077; H01M 2300/008; H01M 2300/0094

(57) ABSTRACT

Provided is an all-solid-state secondary battery including a positive electrode, a negative electrode spaced apart from the positive electrode, a solid electrolyte layer disposed between the positive electrode and the negative electrode, and an intermediate layer disposed between the solid electrolyte layer and the negative electrode, the intermediate layer includes a first solid electrolyte and a first binder having a hydroxy group as a terminal group, and the solid electrolyte layer includes a second solid electrolyte.

### CROSS-REFERENCE TO RELATED APPLICATIONS

This U.S. Non-provisional patent application claims priority under 35 U.S.C. § 119 of Korean Patent Application Nos. 10-2024-0175589, filed on Nov. 29, 2024, and 10-2025-0048180, filed on Apr. 14, 2025, the entire contents of which are hereby incorporated by reference.

### BACKGROUND

### 1. Field of the Invention

The present disclosure herein relates to an all-solid-state secondary battery, and a manufacturing method for the same, and more particularly, to an all-solid-state secondary battery including an intermediate layer, and a manufacturing method for the same.

### 2. Description of Related Art

Recently, development of batteries with high energy density and safety has been actively carried out due to industrial demands. For example, lithium-ion batteries are being commercialized not only in fields of information-related devices and communication devices but also in an automotive field. In the automotive field, safety is particularly emphasized because it is related to life.

Recently, research has been conducted on all-solid-state secondary batteries, which replace an electrolyte solution of the lithium-ion batteries with a solid electrolyte. All-solid-state secondary batteries can secure stability and mechanical strength, thus drawing attention in various application systems that require high safety, such as electric vehicles, energy storage systems, and wearable devices.

### SUMMARY

The present disclosure herein provides an all-solid-state secondary battery having improved ionic conductivity and stability.

The present disclosure also provides a method of manufacturing an all-solid-state secondary battery having improved ionic conductivity and stability.

The task to be solved by the present invention is not limited to what is mentioned above, and yet other tasks not mentioned will be clearly understood by those skilled in the art from the description below.

An embodiment of the present invention provides an all-solid-state secondary battery including a positive electrode, a negative electrode spaced apart from the positive electrode, a solid electrolyte layer disposed between the positive electrode and the negative electrode, and an intermediate layer disposed between the solid electrolyte layer and the negative electrode, the intermediate layer may include a first solid electrolyte and a first binder having a hydroxy group as a terminal group, and the solid electrolyte layer may include a second solid electrolyte.

In some embodiments, the first solid electrolyte may have a diameter of about 500 nm to about 3 μm.

In some embodiments, the first and second solid electrolytes may each include at least one among Li₄₋ₓGe₁₋ₓPₓS₄, Li₃PS₄ glass-ceramic, Li₇P₃S₁₁ glass-ceramic, Li₄SnS₄, Li₆PS₅X (X=I, Br, Cl), Li₃ErX₆, Li₃GdX₆, Li₃YX₆, Li₃InX₆ (X=I, Cl, Br), Li₁₊ₓTi₂₋ₓMₓ(PO₄)₃(M=Al, Ga, In, Sc) or Li₇La₃Zr₂Oi₂, or a combination thereof.

In some embodiments, the negative electrode may include a negative electrode current collector, and a negative electrode active material layer on the negative electrode current collector, and the negative electrode active material layer may include a first negative electrode active material and a second negative electrode active material.

In some embodiments, the first negative electrode active material may include at least one among graphite, hard carbon, soft carbon, carbon nanotube, graphene, reduced graphene oxide, a carbon fiber, amorphous carbon, or highly oriented pyrolytic graphite (HOPG).

In some embodiments, the second negative electrode active material may include at least one among silicon, tin, silicon oxide, cobalt oxide, or iron oxide.

In some embodiments, a weight ratio of the first negative electrode active material to the second negative electrode active material may be about 99:1 to about 50:50.

In some embodiments, the negative electrode active material layer may further include the first solid electrolyte of the intermediate layer, and a density of the first solid electrolyte in the negative electrode active material layer may decrease as a distance from a top surface adjacent to the intermediate layer increases.

In some embodiments, the intermediate layer may have a thickness of about 2 μm to about 10 μm.

In some embodiments, the first binder may include at least one among polybutadiene, a fluorine-based rubber, a nitrile butadiene rubber, a hydrogenated nitrile butadiene rubber, a styrene butadiene rubber, styrene butadiene styrene, styrene ethylene butadiene styrene, an acrylated styrene butadiene rubber, or an acrylonitrile butadiene styrene copolymer.

In an embodiment of the inventive concept, an all-solid-state secondary battery includes a positive electrode including a positive electrode current collector, and a positive electrode active material layer disposed on the positive electrode current collector, a negative electrode including a negative electrode current collector, and a negative electrode active material layer disposed on the negative electrode current collector, and spaced apart from the positive electrode, a solid electrolyte layer disposed between the positive electrode and the negative electrode, and an intermediate layer disposed between the solid electrolyte layer and the negative electrode active material layer. The intermediate may include a first solid electrolyte and a first binder having a hydroxy group as a terminal group, the solid electrolyte layer may include a second solid electrolyte, and the negative electrode active material layer may include a first negative electrode active material, a second negative electrode active material, and the first solid electrolyte.

In some embodiments, the first negative electrode active material may include at least one among graphite, hard carbon, soft carbon, carbon nanotube, graphene, reduced graphene oxide, a carbon fiber, amorphous carbon, or highly oriented pyrolytic graphite (HOPG), and the second negative electrode active material may include at least one among silicon, tin, silicon oxide, cobalt oxide, or iron oxide.

In some embodiments, the first and second solid electrolytes may each include at least one among Li₄₋ₓGe₁₋ₓPₓS₄, Li₃PS₄ glass-ceramic, Li₇P₃S₁₁ glass-ceramic, Li₄SnS₄, Li₆PS₅X (X=I, Br, Cl), Li₃ErX₆, Li₃GdX₆, Li₃YX₆, Li₃InX₆ (X=I, Cl, Br), Li₁₊ₓTi₂₋ₓMₓ(PO₄)₃(M=Al, Ga, In, Sc), or Li₇La₃Zr₂Oi₂, or a combination thereof, and the first and second solid electrolytes may include the same material.

In some embodiments, a density of the first solid electrolyte in the negative electrode active material layer may decrease as a distance from a top surface adjacent to the intermediate layer increases.

In an embodiment of the inventive concept, a method of manufacturing an all-solid-state secondary battery includes preparing a positive electrode and a negative electrode in which pores are formed in a negative electrode active material layer, mixing a first solid electrolyte, a first binder, and a first solvent to manufacture an intermediate layer composition, applying the intermediate layer composition on the negative electrode active material layer and drying to form an intermediate layer, forming a solid electrolyte layer including a second solid electrolyte, and rolling the positive electrode, the solid electrolyte layer, the intermediate layer, and the negative electrode. The first binder may have a hydroxy group as a terminal group, and, the first binder may be included in an amount of about 1 wt % to about 10 wt % based on a total weight of the intermediate layer composition.

In some embodiments, the forming of the intermediate layer on the negative electrode active material layer may further include infiltration of the first solid electrolyte into the pores of the negative electrode active material layer.

In some embodiments, the method of manufacturing an all-solid-state secondary battery may further include rolling the negative electrode and the intermediate layer at a pressure of about 150 MPa to about 200 MPa after the forming of the intermediate layer on the negative electrode active material layer.

In some embodiments, a content of the first solid electrolyte in the intermediate layer composition may be about 0.05 g to about 0.25 g based on 1 mL of intermediate layer composition.

In some embodiments, the first solvent may include at least one among water, ethanol, acetone, isopropyl alcohol, hexane, heptane, nonane, decane, benzene, toluene, xylene, anisole, cyclohexanone, methyl ethyl ketone, tetrahydrofuran, N-methylpyrrolidone, hexamethylphosphoramide, dioxane, tetramethylurea, triethyl phosphate, trimethyl phosphate, dimethylformamide, dimethyl sulfoxide, or dimethylacetamide, or a combination thereof.

In some embodiments, porosity of the negative electrode active material layer before the formation of the intermediate layer on the negative electrode active material layer may be about 50% to about 70%.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of an all-solid-state secondary battery according to embodiments of the inventive concept;

FIG. 2 is an enlarged view of portion ‘P1’ in FIG. 1;

FIG. 3A is an enlarged view of portion ‘P2’ in FIG. 2;

FIG. 3B is a cross-sectional view of a negative electrode active material according to embodiments of the inventive concept;

FIG. 4 is a conceptual view describing self-healing properties of a first binder according to embodiments of the inventive concept;

FIG. 5 is a schematic view of an intermediate layer composition according to embodiments of the inventive concept;

FIG. 6 is a flow chart showing a manufacturing method of an all-solid-state secondary battery according to embodiments of the inventive concept;

FIG. 7 is an image showing the intermediate layer compositions according to Example 1, Comparative Example 1, and Comparative Example 2;

FIG. 8 is an analysis result of a nanoindentation test for the intermediate layer compositions according to Example 1, Comparative Example 1, Comparative Example 2 of the inventive concept;

FIG. 9 shows analysis results of scanning electron microscopy (SEM) and EDS-mapping on surfaces of negative electrodes according to embodiments of inventive concept;

FIG. 10 shows analysis results of scanning electron microscope (SEM) and EDS-mapping analysis on the negative electrode surfaces and negative electrode cross-sections according to embodiments of the inventive concept;

FIG. 11 illustrates schematic cross-sectional views of all-solid-state secondary batteries manufactured according to Example 4, Comparative Example 3, and Comparative Example 4, after charging and discharging; and

FIG. 12 is a graph of evaluation of lifespan characteristics of the all-solid-state batteries manufactured according to Example 4, Comparative Example 3, and Comparative Example 4 of the inventive concept.

### DETAILED DESCRIPTION OF THE INVENTION

In order to sufficiently understand the configuration and effect of the present invention, preferred embodiments of the present invention will be described with reference to the accompanying drawings. It should be noted, however, that the present invention is not limited to the following exemplary embodiments, may be implemented in various forms, and may be variously modified. Rather, the embodiments are provided only to disclose the present invention completely and let those skilled in the art fully know the scope of the invention.

In the description, when an element is referred to as being on another element, the element may be directly formed on the other element or intervening elements may be present therebetween. In addition, in the drawings, thicknesses of components are exaggerated for effectively explaining the technical contents. Like reference numerals and symbols indicate like elements throughout the specification.

Embodiments described herein will be described with reference to cross-sectional and/or plan views, which are idealized illustrations of the present invention. In the drawings, thicknesses of a layer and regions are exaggerated for effectively describing the technical contents. Accordingly, the regions illustrated in the drawings are schematic in nature, and the shapes of the regions illustrated in the drawings are for exemplifying particular shapes of element regions and are not intended to limit the scope of the invention. In various embodiments of the present invention, although the terms first, second, and third are used to describe various components, such components should not be limited by these terms. These terms are merely used to distinguish one component from another. Embodiments described and exemplified herein also include complementary embodiments thereof.

The terminology used herein is only for the purpose of describing embodiments and is not intended to limit the invention. In this specification, the singular form may include the plural form as well, unless specifically stated otherwise. It will be further understood that the terms “comprises” and/or “comprising”, when used in this specification, do not preclude the possibility of the presence or addition of one or more other components.

As used herein, the wordings such as “A or B”, “at least one among A and B”, “at least one of A or B”, “A, B, or C”, “at least one among A, B, and C”, and “at least one of A, B, or C” may include any one among listed items together with the corresponding wording among the wordings, or all possible combinations thereof.

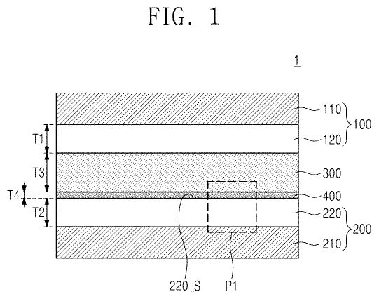

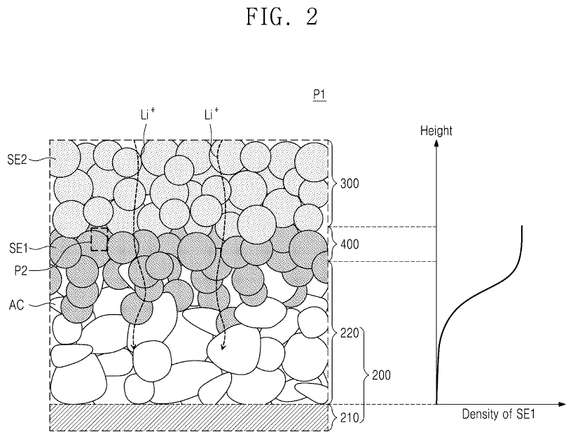

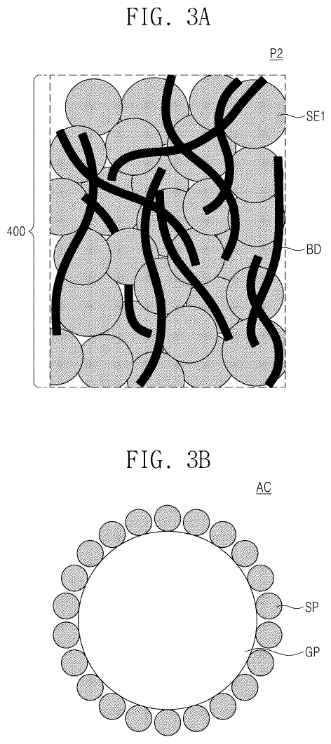

FIG. 1 is a cross-sectional view of an all-solid-state secondary battery according to embodiments of the inventive concept. FIG. 2 is an enlarged view of portion ‘P1’ in FIG. 1. FIG. 3A is an enlarged view of portion ‘P2’ in FIG. 2. FIG. 3B is a cross-sectional view of a negative electrode active material according to embodiments of the inventive concept.

Referring to FIG. 1 and FIG. 2, an all-solid-state secondary battery 1 according to embodiments of the inventive concept may include a positive electrode 100, a negative electrode 200, a solid electrolyte layer 300, and an intermediate layer 400. The solid electrolyte layer 300 may be disposed between the positive electrode 100 and the negative electrode 200. That is, the positive electrode 100 and the negative electrode 200 may be spaced apart from each other with the solid electrolyte layer 300 therebetween.

The positive electrode 100 may include a positive electrode current collector 110, and a positive electrode active material layer 120 disposed on the positive electrode current collector 110. The positive electrode active material layer 120 may include a positive electrode active material, a positive electrode solid electrolyte, a positive electrode conductive material, and a positive electrode binder. Pores of the positive electrode active material layer 120 may be about 1 volume % to about 20 volume % with respect to 100 volume % of the positive electrode active material layer 120. Preferably, the pores may be about 5 volume % to about 15 volume %.

The positive electrode current collector 110 may include, for example a plate or a foil including indium (In), copper (Cu), magnesium (Mg), stainless-steel, titanium (Ti), iron (Fe), cobalt (Co), nickel (Ni), zinc (Zn), aluminum (Al), germanium (Ge), or an alloy thereof.

The positive electrode active material may include at least one among, for example, lithium cobalt oxide (LiCoO₂), lithium nickel oxide (LiNiO₂), lithium manganese oxide (LiMnO₄), lithium nickel cobalt aluminum oxide (LiNiCoAlO₂), or olivine (LiFePO₄), lithium nickel manganese cobalt oxide (LiCoₓMn_{y}Ni_{z}O₂; x+y+z=1), or a mixture thereof, or a solid solution thereof.

The positive electrode solid electrolyte may include, for example: a sulfide-based solid electrolyte such as Li₄₋ₓGe₁₋ₓPₓS₄(LGPS), Li₃PS₄ glass-ceramic, Li₇P₃S₁₁ glass-ceramic (LPS) or Li₄SnS₄, Li₆PS₅X (X=I, Br, Cl); a halogen-based solid electrolyte such as Li₃ErX₆, Li₃GdX₆, Li₃YX₆, or Li₃InX₆ (X=I, Cl, Br); or an oxide-based solid electrolyte such as Li₁₊ₓTi₂₋ₓMₓ(PO₄)₃(M=Al, Ga, In, Sc) or Li₇La₃Zr₂Oi₂(LLZO).

The positive electrode conductive material may include a material having conductivity, and may increase conductivity of the positive electrode active material. The positive electrode conductive material may include a carbon-based material. The positive electrode conductive material may include at least one among, for example, graphite, hard carbon, soft carbon, carbon fiber, carbon nanotube, linear carbon, carbon black, acetylene black, or Ketjen black.

The positive electrode binder may mutually bind the positive electrode active material, the positive electrode solid electrolyte, and the positive electrode conductive material, and the like in the positive electrode active material layer 120. The positive electrode binder may serve to maintain adhesion between the electrode material and a metal foil after applying a positive electrode slurry on the positive electrode current collector 110. The positive electrode binder may include a material for improving adhesion between the positive electrode active material layer 120 and the positive electrode current collector 110.

The positive electrode binder may include, for example, at least one among polyvinylidene fluoride, polyimide, polytetrafluoroethylene, poly(ethylene oxide), polyacrylonitrile, hydroxypropyl cellulose, carboxymethyl cellulose, sodium (Na)-carboxymethyl cellulose, styrene-butadiene rubber, nitrile-butadiene rubber, or a combination thereof.

A content of the positive electrode active material in the positive electrode active material layer 120 may be about 60 wt % to about 88 wt % on a basis of 100 wt % of the positive electrode active material layer 120. More preferably, the content may be about 80 wt % to about 85 wt %.

A content of the positive electrode solid electrolyte in the positive electrode active material layer 120 may be about 10 wt % to about 30 wt % on a basis of 100 wt % of the positive electrode active material layer 120. More preferably, the content may be about 20 wt % to about 25 wt %.

A content of the positive electrode binder in the positive electrode active material layer 120 may be about 1 wt % to about 5 wt % on a basis of 100 wt % of the positive electrode active material layer 120. More preferably, the content may be about 1 wt % to about 2 wt %.

A content of the positive electrode conductive material in the positive electrode active material layer 120 may be about 1 wt % to about 5 wt % on a basis of 100 wt % of the positive electrode active material layer 120. More preferably, the content may be about 1 wt % to about 2 wt %. When a conductivity of the positive electrode active material in the positive electrode active material layer 120 is about 100 S/cm @20° C. or greater, the positive electrode active material layer 120 may not include the positive electrode conductive material.

The negative electrode 200 may include a negative electrode current collector 210, and a negative electrode active material layer 220 disposed on the negative electrode current collector 210. A capacity ratio of the negative electrode 200 to the positive electrode 100 (n/p ratio) may be about 0.7 to about 2.

The negative electrode current collector 210 may include, for example, a plate or a foil including copper (Cu), stainless-steel, titanium (Ti), nickel (Ni), aluminum (Al), or an alloy thereof. The negative electrode active material layer 220 may include a negative electrode active material AC, a negative electrode binder, and a first solid electrolyte SE1.

Referring to FIG. 1 and FIG. 3B, the negative electrode active material AC may include a first negative electrode active material GP, and a second negative electrode active material SP. The negative electrode active material AC may include a material with high electronic conductivity (for example, about 2 S/cm or greater). The second negative electrode active material SP may be disposed on a surface of the first negative electrode active material GP. Alternatively, unlike what is illustrated, the first negative electrode active material GP may include the second negative electrode active material SP therein.

The first negative electrode active material GP may include, for example, a carbon-based material such as graphite, hard carbon, soft carbon, a carbon nanotube, graphene, reduced graphene oxide, a carbon fiber, amorphous carbon, or highly oriented pyrolytic graphite (HOPG). The second negative electrode active material SP may include a material with low mechanical deformation and large volume expansion/contraction upon lithiation/delithiation. Therefore, a capacity of the all-solid-state secondary battery 1 may increase. The second negative electrode active material SP may include, for example, at least one among silicon, tin, silicon oxide, cobalt oxide, or iron oxide.

In the negative electrode active material layer 220, a weight ratio of the first negative electrode active material GP to the second negative electrode active material SP may be about 99:1 to about 50:50. In the negative electrode active material layer 220, a volume ratio of the first negative electrode active material GP to the second negative electrode active material SP may be about 90:10 to about 50:50.

Referring to FIG. 1 and FIG. 2 again, the negative electrode binder may serve to physically or chemically bind the first negative electrode active material GP and the second negative electrode active material SP. A content of the negative electrode binder in the negative electrode active material layer 220 may be about 1 wt % to about 5 wt % on a basis of 100 wt % of the negative electrode active material layer 220.

The negative electrode binder may include, for example, at least one among polytetrafluoroethylene, polyvinylidene fluoride, poly(ethylene oxide), polyacrylonitrile, hydroxypropyl cellulose, carboxymethyl cellulose, styrene-butadiene, or nitrile-butadiene rubber.

In an embodiment, for improving conductive properties of lithium ions, ionic conductive properties may be imparted to the negative electrode binder by adding lithium salt. The lithium salt may be, for example, at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BOs.

In an embodiment, an electronic conductor may be added for improving electronic conductivity of the negative electrode active material layer 220. The electronic conductor may be, for example, at least one among hard carbon, soft carbon, carbon fiber, carbon nanotube, linear carbon, carbon black, acetylene black, or Ketjen black. A content of the electronic conductor in the negative electrode active material layer 220 may be about 1 wt % to about 5 wt % on a basis of 100 wt % of the negative electrode active material layer 220.

The negative electrode active material layer 220 may not include a sulfide-based solid electrolyte having high reactivity with a solvent, or an oxide-based solid electrolyte sensitive to interfacial properties. The first solid electrolyte SE1 included in the negative electrode active material layer 220 will be described later.

Referring to FIG. 1, FIG. 2, and FIG. 3A, the intermediate layer 400 may be disposed between the solid electrolyte layer 300, and the negative electrode 200. That is to say, the intermediate layer 400 may be disposed between the solid electrolyte layer 300, and the negative electrode active material layer 220. The intermediate layer 400 may cover a top surface 220_S of negative electrode active material layer 220. The intermediate layer 400 may include a first solid electrolyte SE1 and a first binder BD.

The first solid electrolyte SE1 may include, for example, one among: a sulfide-based solid electrolyte such as Li₄₋ₓGe₁₋ₓPₓS₄ (LGPS), Li₃PS₄ glass-ceramic, Li₇P₃S₁₁ glass-ceramic (LPS) or Li₄SnS₄, Li₆PS₅X (where, X=I, Br, Cl); a halogen-based solid electrolyte such as Li₃ErX₆, Li₃GdX₆, Li₃YX₆, or Li₃InX₆ (where, X=I, Cl, Br); an oxide-based solid electrolyte such as Li₁₊ₓTi₂₋ₓMₓ(PO₄)₃(where, M=Al, Ga, In, Sc) or Li₇La₃Zr₂Oi₂(LLZO); or a combination thereof. The first solid electrolyte SE1 may have a diameter of about 500 nm to about 3 μm.

The first binder BD may include, for example, at least one among polybutadiene, a fluorine-based rubber, a nitrile butadiene rubber, a hydrogenated nitrile butadiene rubber, a styrene butadiene rubber, styrene butadiene styrene, styrene ethylene butadiene styrene, an acrylated styrene butadiene rubber, or an acrylonitrile butadiene styrene copolymer. The first binder BD has a hydroxy group as a terminal group, hydrogen bonding between polymer chains is possible, thereby exhibiting self-healing characteristics.

The first binder BD according to an embodiment of the inventive concept may include a compound represented by Formula 1 below.

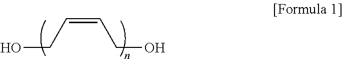

In Formula 1 above, n may be an integer of 2 to 10.

For example, when silicon in the negative electrode active material AC expands/contracts during repeated charging and discharging, graphite of the negative electrode active material AC may function to mitigate expansion/contraction of the silicon in the negative electrode active material layer 220. However, when there is no intermediate layer 400, the top surface 220_S of the negative electrode active material layer 220 comes into contact with the solid electrolyte layer 300, and thus so significant expansion/contraction of silicon may occur at an interfacial region between the negative electrode active material layer 220 and the solid electrolyte layer 300. The intermediate layer 400 between the negative electrode active material layer 220 and the solid electrolyte layer 300 includes the first binder BD having flexibility and self-healing characteristics, and thus may mitigate expansion/contraction of the silicon.

The solid electrolyte layer 300 may serve to transfer ions between the positive electrode 100 and the negative electrode 200. The solid electrolyte layer 300 may include a second solid electrolyte SE2. The first solid electrolyte SE1 and the second solid electrolyte SE2 may include the same material. However, an embodiment of the inventive concept is not limited thereto, and the first solid electrolyte SE1 and the second solid electrolyte SE2 may include materials different from each other. The second solid electrolyte SE2 may include at least one among an oxide-based solid electrolyte, a phosphate-based solid electrolyte, a sulfide-based solid electrolyte, a polymer-based solid electrolyte, or a combination thereof.

The oxide-based solid electrolyte may be, for example, one selected from Garnet-structured materials having a composition of Li_{7-3x+y-z}AₓLa_{3-y}B_{y}Zr_{2-z}C_{z}O₁₂ (where, A=Al, Ga/B=Ca, Sr, Ba/C=Ta, Nb, Sb, Bi). For example, in a case of Li₇₋ₓAₓLa₃Zr₂Oi₂, Li may be doped with a doping element such as Al, and Ga (a ratio of about 0˜0.3 mol), and Zr may be doped with a doping element such as Nb, and Ta (a ratio of about 0˜0.3 mol). For example, Li₃ₓLa_{(2/3)-x□(1/3)-2x}TiO₃ (LLTO, where, 0<x<0.16, □: vacancy), which is a material having a Perovskite structure, may be selected.

The phosphate-based solid electrolyte may be, for example, one selected from Naisicon-structured materials of Li₁₊ₓAlₓTi₂₋ₓ(PO₄)₃(where, x=0˜0.4).

The sulfide-based solid electrolyte may be, for example, one selected from a compound group, which fundamentally contains a chalcogenide element and lithium and consists of: a material such as Li₁₀SnP₂S₁₂, Li₄₋ₓSn₁₋ₓAsₓS₄ (x=0˜100) from a Li_{10±1}MP₂X₁₂ group (where, M=Ge, Si, Sn, Al, or P, and X=S or Se); a material such as Li_{3.25}Ge_{0.25}P_{0.75}S₄, Li₁₀GeP₂S₁₂ from a thio-lithium superionic conductor (thio-LISICON) group; a material such as Li₆PS₅Cl from a Li-argyrodite Li₆PS₅X group (where X=Cl, Br, or I); a material selected from a Li₂S·P₂S₅ (where, xLi₂S·(100-x)P₂S₅, x=0˜100) group having a glass-ceramic structure; a material such as Li₂·P₂S₅, Li₂S·SiS₂·Li₃N, Li₂S·P₂S₅·LiI, Li₂S·SiS₂·LiₓMO_{y}, Li₂S·GeS₂, Li₂S·B₂S₃·LiI from a group having a glassy structure.

The polymer-based solid electrolyte may be at least one among polyethylene oxide (PEO), polyvinyl chloride (PVC), polyacrylonitrile (PAN), poly(methyl methacrylate) (PMMA), polyvinylidene fluoride (PVDF), or a polyvinylidene fluoride-hexafluoropropylene (P(VDF-HFP)) copolymer, or one or more selected from a mixture thereof. In this case, a lithium salt included in the polymer-based solid electrolyte may include at least one among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI or LiPDI, or one selected from combinations thereof.

The solid electrolyte layer 300 may further include a polymer binder, an organic or inorganic scaffold, or the like, which may enhance a mechanical strength of the solid electrolyte layer.

A first thickness T1 of the positive electrode active material layer 120 may be about 1 μm to about 200 m. A second thickness T2 of the negative electrode active material layer 220 may be about 1 μm to about 200 m. A third thickness T3 of the solid electrolyte layer 300 may be about 20 μm to about 1000 m. A fourth thickness T4 of the intermediate layer 400 may be about 2 μm to about 10 am. More preferably, the fourth thickness T4 of the intermediate layer 400 may be about 2 μm to about 5 μm.

The negative electrode active material layer 220 may include a first solid electrolyte SEL. The first solid electrolyte SE1 may be located to a depth of about ⅓ times to about ½ times a second thickness T2 from the top surface 220_S of the negative electrode active material layer 220. As illustrated in FIG. 2, a density of the first solid electrolyte SE1 in the negative electrode active material layer 220 may decrease as a distance from the top surface 220_S adjacent to the intermediate layer 400 increases. That is to say, a region adjacent to the negative electrode current collector 210 in the negative electrode active material 220 may not include the first solid electrolyte SEL. The negative electrode active material layer 220 includes the first solid electrolyte SE1, thereby forming a uniform ion transfer pathway (Li⁺) from the solid electrolyte layer 300 to the negative electrode 200, and thus an energy density may be improved. Therefore, high-speed charging and discharging become possible, and thus capacity and lifespan characteristics of the all-solid-state secondary battery 1 may be improved.

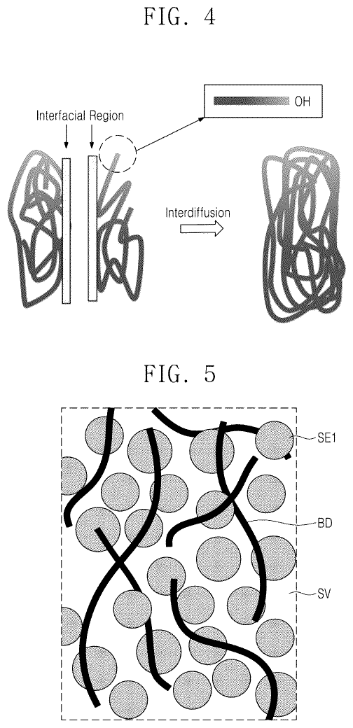

FIG. 4 is a conceptual view describing self-healing properties of a first binder according to embodiments of the inventive concept. FIG. 4 is a view schematically illustrating a mutually entangled state when the content of the first binder is high.

Referring to FIG. 1, FIG. 2, FIG. 3A, and FIG. 4, the first binder BD according to the inventive concept may include a hydroxy group (—OH) at a terminal group. The first binder BD may recombine, through hydrogen bonding via a hydroxy group (−OH) between polymer chains, by interdiffusion between the interfacial regions of the separated first binder BD. In this case, even if temporary cracks occur at the interfacial regions between the materials inside the battery during the repeated charging and discharging, the self-healing characteristic of the binder allows the binders to combine, thereby improving the binding strength at the interfacial region between the materials and thus enabling the battery to recover. That is, due to the first binder BD in the intermediate layer 400 according to the inventive concept, interactions (i.e., bonding) between the broken first binders BD caused by repeated charging and discharging may be recovered.

That is to say, in the all-solid-state secondary battery 1 according to the inventive concept, the intermediate layer 400 including the first binder BD is disposed between the solid electrolyte layer 300 and the negative electrode 200, and thus binding strength between the intermediate layer 400 and the negative electrode 200 may be improved, and cracks and/or deterioration between the solid electrolyte layer 300 and the negative electrode 200 may be prevented. Therefore, the all-solid-state secondary battery 1 may have a minimized driving pressure and improved mechanical stability, and thus lifespan characteristics of the battery may be improved.

FIG. 5 is a schematic view of an intermediate layer composition according to embodiments of the inventive concept.

Referring to FIG. 5, an intermediate layer composition 400C may include a first solvent SV, a first solid electrolyte SE1, and a first binder BD.

The first solvent SV may include a nonpolar, semi-polar, or non-reactive material that does not deteriorate the properties of the first solid electrolyte SE1. The first solvent SV may include, for example, at least one among water, ethanol, acetone, isopropyl alcohol, hexane, heptane, nonane, decane, benzene, toluene, xylene, anisole, cyclohexanone, methyl ethyl ketone, tetrahydrofuran, N-methylpyrrolidone, hexamethylphosphoramide, dioxane, tetramethylurea, triethyl phosphate, trimethyl phosphate, dimethylformamide, dimethyl sulfoxide, or dimethylacetamide, or a combination thereof.

The first solid electrolyte SE1 and the first binder BD are the same as described previously.

A content of the first binder BD in the intermediate layer composition 400C may be about 1 wt % to about 10 wt % on a basis of 100 wt % of the intermediate layer composition 400C. More preferably, the content may be about 3 wt % to about 5 wt %.

A content of the first solid electrolyte SE1 in the intermediate layer composition 400C may be about 0.05 g to about 0.25 g based on 1 mL of the intermediate layer composition 400C. More preferably, the content may be about 0.05 g to about 0.15 g.

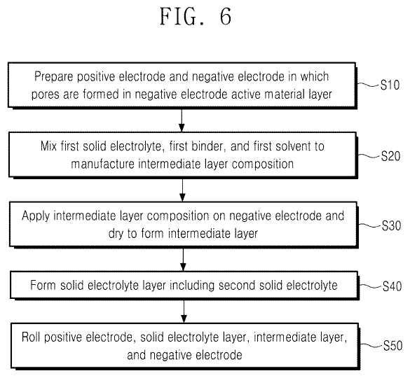

FIG. 6 is a flow chart showing a manufacturing method of an all-solid-state secondary battery according to embodiments of the inventive concept.

Referring to FIG. 1, FIG. 2, FIG. 5, and FIG. 6, the positive electrode 100, and the negative electrode 200 in which a pore is formed in the negative electrode active material layer 220 may be prepared (S10).

First, a positive electrode active material, a positive electrode solid electrolyte, a positive electrode conductive material, a positive electrode binder, and a positive electrode solvent may be mixed to manufacture a positive electrode slurry. Thereafter, a positive electrode slurry may be applied on a metal foil (as an example of a positive electrode current collector 110) to a thick film, the positive electrode slurry may be dried to remove a positive electrode solvent, and then the positive electrode 100 may be manufactured through an additional pressing process.

A negative electrode active material AC, a negative electrode binder, a negative electrode solvent may be mixed to manufacture a negative electrode slurry. In an embodiment, the negative electrode active material AC may include a high-capacity active material (for example, silicon) and soft graphite in order to mitigate volume expansion/contraction of the negative electrode 200. The negative electrode binder and the negative electrode solvent may include an aqueous binder and an aqueous solvent having high binding strength/adhesion regardless of the solid electrolyte.

Generally, for ion transfer, the solid electrolyte in the negative electrode active material layer should be included in an amount of about 30 wt % or greater on a basis of 100 wt % of the negative electrode active material layer. However, in the inventive concept, a porous negative electrode 200, through which the intermediate layer composition 400C in a slurry form may smoothly infiltrate, may be manufactured. Therefore, since pores of the negative electrode active material layer 220 are uniformly distributed between the negative electrode active materials AC, a uniform ion transfer pathway (Li⁺) as illustrated in FIG. 2 may be formed even with a relatively small amount of solid electrolyte, and thus an energy density may be improved. For example, the solid electrolyte (for example, the first solid electrolyte SE1 according to the inventive concept) may be included in an amount of about 5 wt % to about 20 wt % on a basis of 100 wt % of the negative electrode active material layer 220.

The negative electrode slurry may be applied on the negative electrode current collector 210 to a thick film through a casting process using a doctor blade and the like. The negative electrode active material layer 220 may be formed by drying the negative electrode slurry to completely evaporate the negative electrode solvent. The drying process may be performed using, for example, vacuum drying. After the drying process, a porosity of the negative electrode active material layer 220 may be about 50% to about 70%. In order to maintain a porous structure of the negative electrode active material layer 220, an additional pressing/calendaring process may not be proceeded.

The intermediate layer composition 400C may be manufactured by mixing the first solid electrolyte SE1, the first binder BD, and the first solvent SV (S20). For example, the intermediate layer composition 400C may be manufactured by manufacturing a solution that contains the first solvent SV and the first binder BD at a weight ratio of about 95:1, and adding and mixing about 0.3 g of solid electrolyte powder to about 3 mL of the manufactured solution.

The intermediate layer composition 400C may be applied on the negative electrode active material layer 220 and dried, and thus the intermediate layer 400 may be formed (S30). The intermediate layer composition 400C may be applied on the negative electrode active material layer 220 through tape casting using a doctor blade and the like. Alternatively, the intermediate layer composition 400C may be applied on the negative electrode active material layer 220 through various processes such as spray coating, aerosol coating, and screen printing. The coating process may be performed at a room temperature, or under heated conditions of about 30° C. to about 50° C. In this case, the intermediate layer composition 400C may infiltrate in a pore of the negative electrode active material layer 220. That is, the first solid electrolyte SE1 of the intermediate layer composition 400C may infiltrate in the pore of the negative electrode active material layer 220.

Then, all the first solvent SV of the intermediate layer composition 400C may be evaporated through drying at a high temperature. The drying process may be performed, for example, at about 60° C. to about 80° C. for about 1 hour or less. Vacuum drying may be utilized for effective evaporation of the solvent and the sufficient infiltration of the intermediate layer composition 400C into the negative electrode active material layer 220.

Thereafter, the negative electrode 200 and the intermediate layer composition 400C are pressed at a pressure of about 150 MPa to about 200 MPa, and thus the intermediate layer 400 may be formed on the negative electrode 200. The intermediate layer 400 may be formed to a thickness of about 2 μm to about 10 μm. More preferably, the intermediate layer may be formed to a thickness of about 2 μm to about 5 m. This is because if the thickness is too great, interfacial resistance increases, and if it is too small, it is difficult to provide sufficient mechanical interfacial stability. The intermediate layer 400 has a flexibility due to the first binder BD and thus minimize a performance degradation of the all-solid-state secondary battery during charging and discharging, and since it only requires a low external pressure, a configuration of a battery module or pack may be simplified.

The first solid electrolyte SE1 may be located to a depth of about ⅓ times to about ½ times a second thickness T2 from the top surface 220_S of the negative electrode active material layer 220. A density of the first solid electrolyte SE1 in the negative electrode active material layer 220 may decrease as a distance from the top surface 220_S adjacent to the intermediate layer 400 increases. This is because the intermediate layer composition 400C is in a slurry form, and the first solid electrolyte SE1 is not completely dissolved in the first solvent SV and maintains an original spherical shape in the intermediate layer composition 400C, thereby preventing complete infiltration like a liquid. Therefore, performance degradation of the battery caused by a decrease in an ionic conductivity when the first solid electrolyte SE1 dissolves in the first solvent SV and completely infiltrates the negative electrode active material layer 220, may be prevented.

The solid electrolyte layer 300 including a second solid electrolyte SE2 may be formed (S40). For example, the solid electrolyte layer 300 may be formed into a pellet shape by cold sintering about 150 mg of LPSCl powder at a pressure of about 50 MPa to about 100 MPa through a cold or hot sintering process.

The positive electrode 100, the solid electrolyte layer 300, the intermediate layer 400, and the negative electrode 200 may be rolled (S50). The all-solid-state secondary battery may be manufactured by positioning the positive electrode 100, the solid electrolyte layer 300, the intermediate layer 400, and the negative electrode 200 in sequence, and then rolling at a pressure of about 100 MPa to about 300 MPa though a unidirectional or isostatic pressing process. As described above, when a counter electrode is the positive electrode 100, the all-solid-state secondary battery may be a full-cell. Alternatively, unlike what is illustrated, when the counter electrode is lithium or an alloy including lithium, the all-solid-state secondary battery may be a half-cell.

Hereinafter, the inventive concept will be described in more detail through Examples and Comparative Examples. However, these Examples are intended to describe the inventive concept by way of example, and the scope of the inventive concept is not limited thereto.

### Manufacture of Intermediate Layer Composition

### Example 1

A solution including anisole as a solvent and polybutadiene as a binder at a weight ratio of about 95:5 was manufactured. 0.3 g of Li₆PS₅Cl (LPSCl) solid electrolyte powder was added and mixed to 3 mL of the manufactured solution to manufacture an intermediate layer composition.

### Comparative Example 1

An intermediate layer composition was manufactured in the same manner as the above-described composition according to Example 1 except that ethanol was used in place of anisole as a solvent and a binder is not included.

### Comparative Example 2

An intermediate layer composition was manufactured in the same manner as the above-described composition according to Example 1 except that tetrahydrofuran was used in place of anisole as a solvent and a binder is not included.

### Negative Electrode Manufacture

### Example 2

Graphite was used as the first negative electrode active material and silicon was used as the second negative electrode active material. As the binder, sodium carboxymethyl cellulose (NaCMC) and styrene butadiene rubber binder (SBR) were dissolved in DI water such that a weight ratio of NaCMC, SBR, and DI water was about 1:1:8. Next, 10 g of the negative electrode slurry was manufactured such that graphite, silicon, NaCMC, SBR were included at a weight ratio of about 87.3:9.7:1.5:1.5.

The manufactured negative electrode slurry was mixed using a planetary mixer at about 2000 rpm for about 10 minutes, and DI water was additionally added if necessary to achieve a viscosity of about 100 cP to about 500 cP. The negative electrode was applied with a thickness thereof controlled by adjusting a doctor blade gap, and a capacity per unit area was determined by adjusting a loading level according to the thickness of the negative electrode.

The obtained product was primarily dried in an atmospheric pressure oven at 110° C., and dried for about 12 hours in a vacuum oven at 100° C. to remove a solvent remaining in the negative electrode. To maintain a porous structure in the negative electrode formed after drying, an additional pressing/calendaring process was not applied. A weight, an area, and a thickness of the negative electrode were measured, and porosity in the negative electrode could be controlled within a range of about 50% to about 60% through a density and a relative weight ratio of each constituent component. A loading amount of the manufactured negative electrode was about 6.58 mg/cm². A theoretical areal capacity of the negative electrode may be calculated as about 4.54 mAh/cm² based on theoretical capacities of graphite and silicon (graphite: 372 mAh/g, silicon: 3,579 mAh/g).

### Manufacture of Intermediate Layer on Negative Electrode

### Example 3

The intermediate layer composition manufactured according to Example 1 was applied using a doctor blade on the negative electrode manufactured according to Example 2. Thereafter, the obtained was pressed at about 200 MPa to manufacture an intermediate layer on the negative electrode. A thickness of the intermediate layer on the negative electrode, excluding the solid electrolyte infiltrated into the negative electrode, was about 2 μm to about 5 μm.

Manufacture of all-Solid-State Secondary Battery

### Example 4

150 mg of LPSCl powder was cold sintered into a pellet form at a pressure of 50 MPa to about 100 MPa to manufacture a solid electrolyte layer. Then, the negative electrode and the intermediate layer, manufactured according to Example 3 and a 300 μm thick lithium metal electrode/positive electrode were sequentially positioned on both sides of the solid electrolyte layer. Subsequently, a pressure of 350 MPa was applied to manufacture an all-solid-state half cell in which the lithium metal electrode/or positive electrode, the negative electrode, the solid electrolyte layer, and the intermediate layer were integrated.

### Comparative Example 3

An all-solid-state half-cell was manufactured in the same manner as the above-described all-solid-state half-cell according to Example 4 except that porosity of the negative electrode manufactured according to Example 2 is lowered to about 10% or less through a pressing process, and an intermediate layer is not present on the negative electrode.

### Comparative Example 4

A negative electrode was manufactured in the same manner as the above-described negative electrode according to Example 2 except that, as a binder, nitrile butadiene rubber (NBR) was dissolved in anisole such that a weight ratio of NBR to anisole was about 2:8, and 10 g of a negative electrode slurry was manufactured such that graphite, silicon, LPSCl, NBR were included such that a weight ratio was 74.7:8.3:14:3 in the negative electrode slurry.

However, the negative electrode formed after drying was subjected to a pressing process to remove a pore in the negative electrode. A loading amount of the manufactured negative electrode was about 6.58 mg/cm². A theoretical areal capacity may be calculated as about 4.54 mAh/cm² based on theoretical capacities of graphite and silicon (graphite: 372 mAh/g, silicon: 3,579 mAh/g).

Thereafter, an all-solid-state half-cell was manufactured in the same manner as the cell according to Example 4 except that there is no intermediate layer on the negative electrode.

### [Experimental Example 1]Comparison of Dispersity

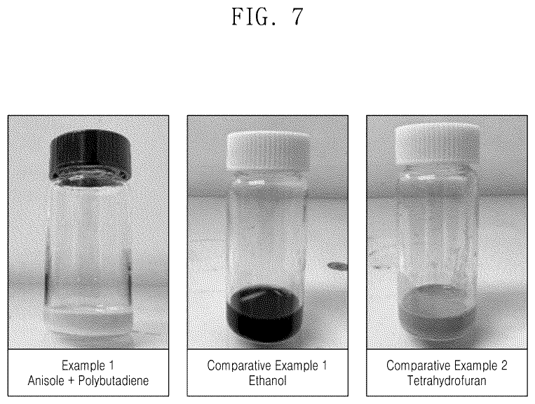

FIG. 7 is an image showing the intermediate layer compositions according to Example 1, Comparative Example 1, and Comparative Example 2.

In the case of Example 1, it can be seen that the LPSCl solid electrolyte is dispersed in the solvent in an original state thereof since the LPSCl solid electrolyte does not react with anisole.

In the case of Comparative Example 1, it can be seen that the LPSCl solid electrolyte is completely dissolved in ethanol.

In the case of Comparative Example 2, it can be seen that the LPSCl solid electrolyte is partially dissolved in tetrahydrofuran.

### [Experimental Example 2] Analysis of Nanoindentation Test

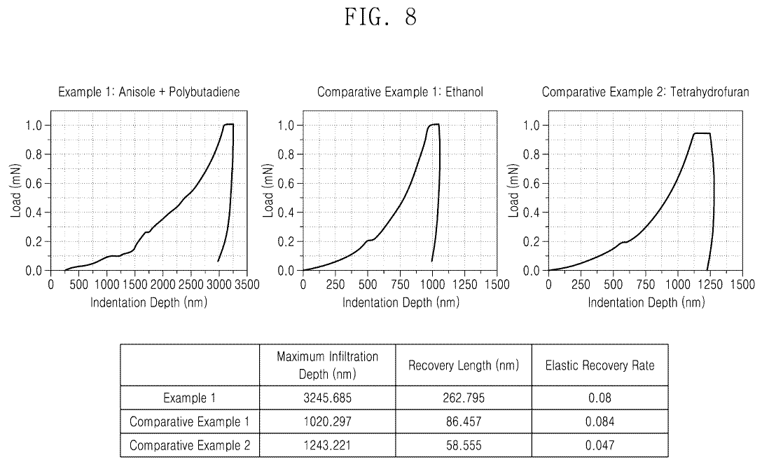

FIG. 8 is an analysis result of a nanoindentation test for the intermediate layer compositions according to Example 1, Comparative Example 1, Comparative Example 2 of the inventive concept. FIG. 8 shows the results of the mechanical property analysis, performed through nanoindentation on each intermediate layer composition from FIG. 7 after applying and drying each intermediate layer composition in a film form.

The intermediate layer composition according to Example 1 was measured to have a maximum infiltration depth of about 3245.6 nm, a recovery length of about 262.7 nm, and an elastic recovery rate of about 0.08.

The intermediate layer composition according to Comparative Example 1 was measured to have a maximum infiltration depth of about 1020.2 nm, a recovery length of about 86.4 nm, and an elastic recovery rate of about 0.084.

The intermediate layer composition according to Comparative Example 2 was measured to have a maximum infiltration depth of about 1243.2 nm, a recovery length of about 58.5 nm, and an elastic recovery rate of about 0.047.

From the analysis, it can be seen that the intermediate layer composition according to Example 1 is soft and highly ductile, and thus may subsequently form an intimate interfacial region with the solid electrolyte layer and the negative electrode, whereas the intermediate layer compositions according to Comparative Example 1 and Comparative Example 2 exhibit relatively hard physical property, and thus may make it difficult to subsequently form an intimate interfacial region with the solid electrolyte layer and the negative electrode.

### [Experimental Example 3] Surface SEM Analysis

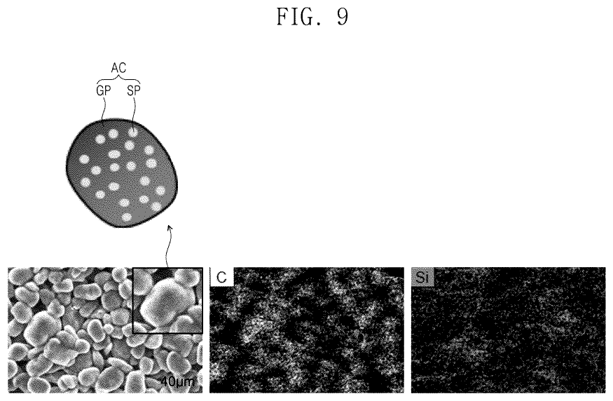

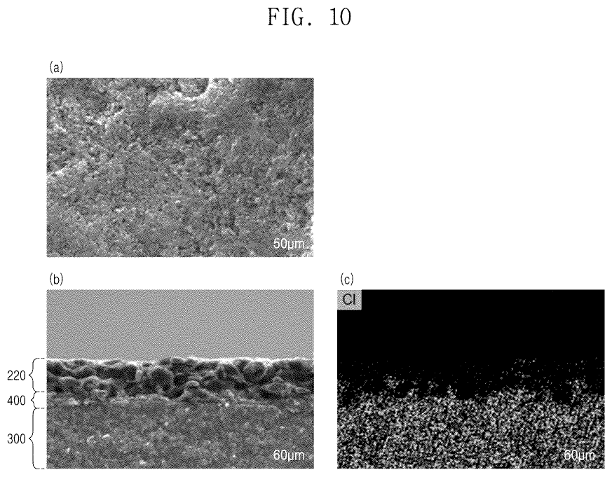

FIG. 9 shows analysis results of scanning electron microscopy (SEM) and EDS-mapping on surfaces of negative electrodes according to embodiments of inventive concept.

FIG. 9 shows an image of the negative electrode surface in which the negative electrode active material AC includes a first negative electrode active material GP and a second negative electrode active material SP. The first negative electrode active material GP may be graphite (C), and the second negative electrode active material SP may be silicon (Si). In an embodiment, a weight ratio of graphite (C) to silicon (Si) is about 9:1, and thus it can be seen that most of silicon (Si) particles are distributed on a surface of graphite (C). In addition, after applying on the negative electrode and drying, an additional rolling/calendaring process was not applied, and thus it can be seen that porosity is high.

### [Experimental Example 4] SEM Analysis of Surface and Cross-Section

FIG. 10 shows analysis results of scanning electron microscope (SEM) and EDS-mapping analysis on the negative electrode surfaces and negative electrode cross-sections according to embodiments of the inventive concept.

FIG. 10 shows a surface image (a) of the negative electrode after applying/and drying of the intermediate layer according to Example 1 on the negative electrode and a cross-sectional image (b) showing the intermediate layer formed after pressing at about 200 MPa. Referring to (a), it can be seen that LPSCl solid electrolytes are uniformly distributed on the surface of the negative electrode after applying. Referring to (b), it can be seen that, as a result of the analysis, the intermediate layer forms intimate interfacial regions with the solid electrolyte layer and the negative electrode and the intermediate layer excluding the solid electrolyte infiltrating into the negative electrode was formed to a thickness of about 2 μm to about 5 μm.

Referring to (c), it can be seen that, through a mapping analysis of a Cl element, among the elements constituting a LPSCl solid electrolyte, the solid electrolyte has infiltrated into the negative electrode, and a distribution ratio of the solid electrolyte decreases as a distance from the surface of the negative electrode increases.

### [Example 5] Comparison of Interfacial Region after Charging and Discharging

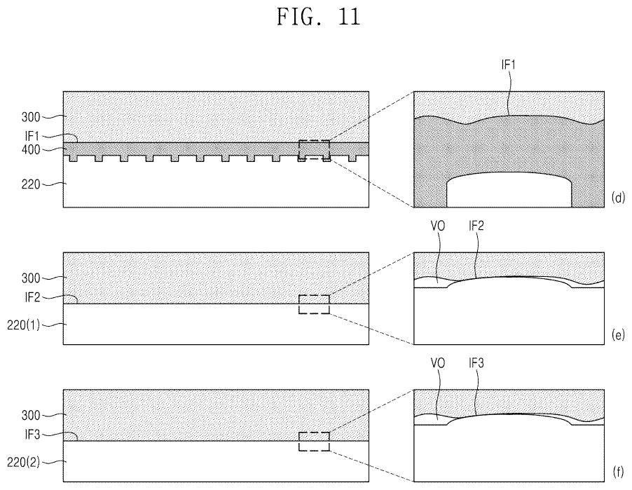

FIG. 11 illustrates schematic cross-sectional views of the all-solid-state secondary batteries manufactured according to Example 4, Comparative Example 3, and Comparative Example 4, after charging and discharging.

(d) illustrates a cross-sectional view of the all-solid-state half-cell manufactured according to Example 4. (e) illustrates a cross-sectional view of the all-solid-state half-cell manufactured according to Comparative Example 3. (f) illustrates a cross-sectional view of the all-solid-state half-cell manufactured according to Comparative Example 4.

A portion of the intermediate layer 400 infiltrates in the surface of a negative electrode active material layer 220 in (d), and thus a bonding strength between a negative electrode active material layer 220 and a intermediate layer 400 is improved. Therefore, it can be seen that a void does not occur in a first interfacial region IF1 between the intermediate layer 400 and the solid electrolyte layer 300.

In (e), an intermediate layer is not disposed between a first negative electrode active material layer 220 (1) and a solid electrolyte layer 300, and thus it can be seen that a void VO may occur in a second interfacial region IF2 between the first negative electrode active material layer 220 (1) and the solid electrolyte layer 300.

In (f), the intermediate layer is not disposed between a second negative electrode active material layer 220 (2) and a solid electrolyte layer 300, and thus it can be seen that a void VO may occur in a third interfacial region IF3 between the second negative electrode active material layer 220 (2) and the solid electrolyte layer 300.

### [Experimental Example 6] Evaluation of Lifespan Characteristics

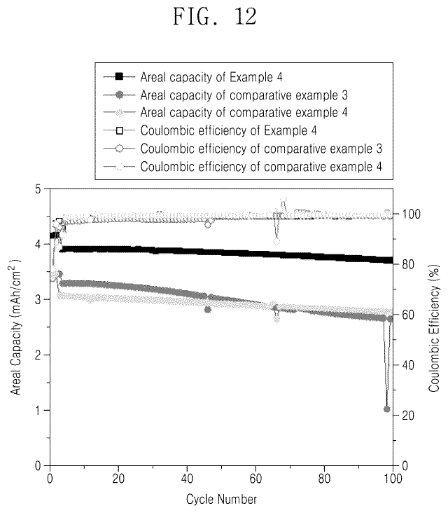

FIG. 12 is a graph of evaluation of lifespan characteristics of the all-solid-state batteries manufactured according to Example 4, Comparative Example 3, and Comparative Example 4 of the inventive concept.

In order to analyze characteristics of charging and discharging, The charging and discharging were performed for a total of 100 cycles using a CC-CV mode at 60° C., and a current density was based on 1 C=4.54 mAh/cm². The charging and discharging were performed for 3 cycles at 0.1 C, followed by the remaining cycles at 0.5 C. A design capacity of each electrode was about 4.55 mAh/cm². Conditions of charging and discharging were at 0.2 C for initial 3 cycles, and at 0.5 C for the remaining cycles at a temperature of about 60° C. and a pressure of about 20 MPa.

The cell according to Example 4 maintained an intimate interfacial region in spite of the repetitive volume expansion/contraction of the negative electrode, and a uniformly distributed ion transfer pathway was formed in the electrode. Therefore, the cell exhibited high capacity and lifespan characteristics (i.e., Coulombic efficiency).

The cell according to Comparative Example 3 resulted in low capacity due to an absence of an ion transfer pathway in the electrode and exhibited a continuous decrease in capacity due to mechanical deterioration caused by repetitive volume expansion/contraction of the negative electrode.

The cell according to Comparative Example 4 exhibited low initial capacity since an ion transfer pathway was poorly formed due to a non-uniform distribution of the solid electrolyte in the electrode, caused by a relatively low content of LPSCl (14 wt %). The cell exhibited a continuous decrease in capacity due to mechanical deterioration caused by repetitive volume expansion/contraction of the negative electrode.

Therefore, it can be confirmed that the all-solid-state secondary battery according to the inventive concept (Example 4) is excellent in results of lifespan characteristic evaluation.

In the all-solid-state secondary battery according to the inventive concept, the intermediate layer is disposed between the solid electrolyte layer and the negative electrode. The uniformly distributed ion transfer pathway is formed due to the intermediate layer, the capacity and the lifespan characteristic of the all-solid-state secondary battery may be improved. In addition, cracks and/or deterioration between the solid electrolyte layer and the negative electrode may be prevented. Therefore, the driving pressure of the all-solid-state secondary battery is minimized, and the mechanical stability is improved, and thus the lifespan characteristics of the battery may be improved.

Hitherto, description has been made with reference to accompanying drawings; however, the present invention may be embodied in other specific forms without changing technical spirit or essential features thereof. Therefore, embodiments described above should be considered in all respects as illustrative and not restrictive.

What is claimed is:

1. An all-solid-state secondary battery comprising:
a positive electrode;
a negative electrode spaced apart from the positive electrode;
a solid electrolyte layer disposed between the positive electrode and the negative electrode; and
an intermediate layer disposed between the solid electrolyte layer and the negative electrode,
wherein the intermediate layer includes a first solid electrolyte and a first binder having a hydroxy group as a terminal group, and
the solid electrolyte layer includes a second solid electrolyte.

2. The all-solid-state secondary battery of claim 1, wherein the first solid electrolyte has a diameter of about 500 nm to about 3 μm.

3. The all-solid-state secondary battery of claim 1, wherein the first and second solid electrolytes each comprise at least one among Li₄₋ₓGe₁₋ₓPₓS₄, Li₃PS₄ glass-ceramic, Li₇P₃S₁₁ glass-ceramic, Li₄SnS₄, Li₆PS₅X (X=I, Br, Cl), Li₃ErX₆, Li₃GdX₆, Li₃YX₆, Li₃InX₆ (X=I, Cl, Br), Li₁₊ₓTi₂₋ₓMₓ(PO₄)₃(M=Al, Ga, In, Sc) or Li₇La₃Zr₂Oi₂, or a combination thereof.

4. The all-solid-state secondary battery of claim 1,
wherein the negative electrode comprises:
a negative electrode current collector; and
a negative electrode active material layer on the negative electrode current collector, and
the negative electrode active material layer includes a first negative electrode active material and a second negative electrode active material.

5. The all-solid-state secondary battery of claim 4, wherein the first negative electrode active material comprises at least one among graphite, hard carbon, soft carbon, carbon nanotube, graphene, reduced graphene oxide, a carbon fiber, amorphous carbon, or highly oriented pyrolytic graphite (HOPG).

6. The all-solid-state secondary battery of claim 4, wherein the second negative electrode active material comprises at least one among silicon, tin, silicon oxide, cobalt oxide, or iron oxide.

7. The all-solid-state secondary battery of claim 4, wherein a weight ratio of the first negative electrode active material to the second negative electrode active material is about 99:1 to about 50:50.

8. The all-solid-state secondary battery of claim 4,
wherein the negative electrode active material layer further comprises the first solid electrolyte of the intermediate layer, and
a density of the first solid electrolyte in the negative electrode active material layer decreases as a distance from a top surface adjacent to the intermediate layer increases.

9. The all-solid-state secondary battery of claim 1, wherein the intermediate layer has a thickness of about 2 μm to about 10 μm.

10. The all-solid-state secondary battery of claim 1, wherein the first binder comprises at least one among polybutadiene, a fluorine-based rubber, a nitrile butadiene rubber, a hydrogenated nitrile butadiene rubber, a styrene butadiene rubber, styrene butadiene styrene, styrene ethylene butadiene styrene, an acrylated styrene butadiene rubber, or an acrylonitrile butadiene styrene copolymer.

11. An all-solid-state secondary battery comprising:
a positive electrode including a positive electrode current collector and a positive electrode active material layer disposed on the positive electrode current collector;
a negative electrode including a negative electrode current collector and a negative electrode active material layer disposed on the negative electrode current collector, and spaced apart from the positive electrode;
a solid electrolyte layer disposed between the positive electrode and the negative electrode; and
an intermediate layer disposed between the solid electrolyte layer and the negative electrode active material layer,
wherein the intermediate layer includes a first solid electrolyte and a first binder having a hydroxy group as a terminal group,
the solid electrolyte layer includes a second solid electrolyte, and
the negative electrode active material layer includes a first negative electrode active material, a second negative electrode active material, and the first solid electrolyte.

12. The all-solid-state secondary battery of claim 11,
wherein the first negative electrode active material comprises at least one among graphite, hard carbon, soft carbon, carbon nanotube, graphene, reduced graphene oxide, a carbon fiber, amorphous carbon, or highly oriented pyrolytic graphite (HOPG), and
the second negative electrode active material comprises at least one among silicon, tin, silicon oxide, cobalt oxide, or iron oxide.

13. The all-solid-state secondary battery of claim 11,
wherein the first and second solid electrolytes each comprise at least one among Li₄₋ₓGe₁₋ₓPₓS₄, Li₃PS₄ glass-ceramic, Li₇P₃S₁₁ glass-ceramic, Li₄SnS₄, Li₆PS₅X (X=I, Br, Cl), Li₃ErX₆, Li₃GdX₆, Li₃YX₆, Li₃InX₆ (X=I, Cl, Br), Li₁₊ₓTi₂₋ₓMₓ(PO₄)₃ (M=Al, Ga, In, Sc), or Li₇La₃Zr₂O₁₂, or a combination thereof, and
the first and second solid electrolytes comprise the same material.

14. The all-solid-state secondary battery of claim 11, wherein a density of the first solid electrolyte in the negative electrode active material layer decreases as a distance from a top surface adjacent to the intermediate layer increases.

15. A method of manufacturing an all-solid-state secondary battery, the method comprising:
preparing a positive electrode and a negative electrode in which pores are formed in a negative electrode active material layer;
mixing a first solid electrolyte, a first binder, and a first solvent to manufacture an intermediate layer composition;
applying the intermediate layer composition on the negative electrode active material layer and drying to form an intermediate layer;
forming a solid electrolyte layer including a second solid electrolyte; and
rolling the positive electrode, the solid electrolyte layer, the intermediate layer, and the negative electrode,
wherein, the first binder has a hydroxy group as a terminal group, and
the first binder is included in an amount of about 1 wt % to about 10 wt % based on the total weight of the intermediate layer composition.

16. The method of claim 15, wherein the forming of the intermediate layer on the negative electrode active material layer further comprises infiltration of the first solid electrolyte into the pores of the negative electrode active material layer.

17. The method of claim 15, further comprising rolling the negative electrode and the intermediate layer at a pressure of about 150 MPa to about 200 MPa after the forming of the intermediate layer on the negative electrode active material layer.

18. The method of claim 15, wherein a content of the first solid electrolyte in the intermediate layer composition is about 0.05 g to about 0.25 g on a basis of 1 mL of intermediate layer composition.

19. The method of claim 15, wherein the first solvent comprises at least one among water, ethanol, acetone, isopropyl alcohol, hexane, heptane, nonane, decane, benzene, toluene, xylene, anisole, cyclohexanone, methyl ethyl ketone, tetrahydrofuran, N-methylpyrrolidone, hexamethylphosphoramide, dioxane, tetramethylurea, triethyl phosphate, trimethyl phosphate, dimethylformamide, dimethyl sulfoxide, or dimethylacetamide, or a combination thereof.

20. The method of claim 15, wherein porosity of the negative electrode active material layer before the formation of the intermediate layer on the negative electrode active material layer is about 50% to about 70%.
